(19) United States
(12) Patent Application Publication
(10) Pub. No.: US 2013/0063703 A1
(43) Pub. Date: Mar. 14, 2013

(54) SPATIAL LIGHT MODULATION DEVICE AND PROJECTION DISPLAY

(71) Applicants: KAZUNORI HARA, Kumamoto (JP); KAZUKI ABE, Kumamoto (JP)

(72) Inventors: KAZUNORI HARA, Kumamoto (JP); KAZUKI ABE, Kumamoto (JP)

(73) Assignee: Sony Corporation, Tokyo (JP)

(21) Appl. No.: 13/598,961

(22) Filed: Aug. 30, 2012

(30) Foreign Application Priority Data
Sep. 8, 2011 (JP) 2011-196398

(51) Int. Cl. G03B 21/14; G02B 26/00

(52) U.S. Cl. 353/31; 359/290

(57) ABSTRACT

A spatial light modulation device includes: a plurality of pixel circuits provided in correspondence to intersections of scan lines and signal lines; and floating light-blocking layers provided in correspondence to the pixel circuits. Each of the pixel circuits includes a thin film transistor (TFT) device including a lightly doped drain (LDD) region, and each of the floating light-blocking layers is disposed in a region opposed to at least the LDD region, and is disposed closer to the LDD region than the signal line.

### BACKGROUND

The present technology relates to a spatial light modulation device having improved light resistance, and a projection display including the spatial light modulation device.

Recently, a projector that projects an image on a screen has been widely used not only at office but also at home. The projector generates image light through modulating light from a light source by a light valve, and projects the image light on a screen for display. The light valve is configured of a liquid crystal panel that modulates light through active matrix drive of pixels in response to an external image signal.

Recently, luminance of the projector has been progressively increased, and further improvement in light resistance is accordingly demanded for the liquid crystal panel used as the light valve. To improve the light resistance of the liquid crystal panel, it is important to improve performance of a light blocking structure that blocks application of light from a light source to a thin film transistor (TFT) device included in a pixel circuit. For example, as schematically illustrated in FIG. 10, a signal line 230 and a storage capacitor 240 are disposed directly above a lightly doped drain (LDD) region 220 of a TFT device in a circuit substrate 210 such that the signal line 230 and the storage capacitor 240 each also have a role as the light blocking structure. It is to be noted that the content relevant to FIG. 10 is described in International Publication No. WO 01/082273, for example.

### SUMMARY

During projection by a projector, a light source emits light that includes not only a straight component but also an oblique component. Hence, the light blocking structure is preferably disposed as close as possible to the LDD region 220. However, since a signal voltage corresponding to an image signal is applied to the signal line 230, if the signal line 230 is disposed close to the LDD region 220, the signal voltage may cause troubles such as degradation in image quality due to an increase in parasitic capacitance, and an increase in inverse current in the TFT device. Hence, the light blocking structure has not been allowed to be simply disposed close to the LDD region 220.

It is desirable to provide a spatial light modulation device that allows improvement in light blocking performance while reducing occurrence of the above-described troubles, and a projection display including the spatial light modulation device.

According to an embodiment of the present technology, there is provided a spatial light modulation device including: a plurality of pixel circuits provided in correspondence to intersections of scan lines and signal lines; and floating light-blocking layers provided in correspondence to the pixel circuits. Each of the pixel circuits includes a thin film transistor (TFT) device including a lightly doped drain (LDD) region, and each of the floating light-blocking layers is disposed in a region opposed to at least the LDD region, and is disposed closer to the LDD region than the signal line.

According to an embodiment of the technology, there is provided a projection display including a spatial light modulation device, and a drive circuit driving the spatial light modulation device, the spatial light modulation device including: a plurality of pixel circuits provided in correspondence to intersections of scan lines and signal lines; and floating light-blocking layers provided in correspondence to the pixel circuits. Each of the pixel circuits includes a thin film transistor (TFT) device including a lightly doped drain (LDD) region, and each of the floating light-blocking layers is disposed in a region opposed to at least the LDD region, and is disposed closer to the LDD region than the signal line.

In the spatial light modulation device and the projection display according to the embodiments of the technology, the floating light-blocking layer is disposed in the region opposed to at least the LDD region, and is disposed closer to the LDD region than the signal line. This allows the floating light-blocking layer to block not only a straight component of light but also an oblique component thereof from entering the LDD region. Furthermore, the floating light-blocking layer is electrically floating. This eliminates occurrence of troubles such as degradation in image quality due to an increase in parasitic capacitance and an increase in inverse current in the TFT device unlike in the case where the signal line is disposed close to the LDD region. In addition, in the case where the floating light-blocking layer is disposed between the LDD region and the signal line, the floating light-blocking layer prevents an electric field generated by a signal voltage from reaching the LDD region.

According to the spatial light modulation device and the projection display according to the embodiments of the technology, the floating light-blocking layer is disposed in the region opposed to at least the LDD region, and is disposed closer to the LDD region than the signal line. This improves light-blocking performance while suppressing occurrence of the above-described troubles.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a diagram illustrating an exemplary configuration of a display according to an embodiment of the present technology.

FIG. 2 is a diagram illustrating an exemplary configuration of a spatial light modulation section.

FIG. 3 is a diagram illustrating an exemplary circuit configuration of a pixel.

FIG. 4 is a diagram illustrating an exemplary sectional configuration of a portion including the pixel and its vicinity.

FIG. 5 is a characteristic diagram for explaining a variation in flicker value depending on presence or absence of a light blocking layer.

FIGS. 6A and 6B are characteristic diagrams for explaining a variation in inverse current depending on presence or absence of the light blocking layer.

FIG. 7 is a characteristic diagram for explaining a variation in black defect level depending on presence or absence of the light blocking layer and an electric potential of the light blocking layer.

FIG. 8 is a characteristic diagram for explaining a variation in flicker value depending on presence or absence of the light blocking layer and electric potential of the light blocking layer.

FIGS. 9A and 9B are characteristic diagrams for explaining a variation in inverse current depending on presence or absence of the light blocking layer and electric potential of the light blocking layer.

FIG. 10 is a diagram illustrating an exemplary sectional configuration of a circuit substrate in the past.

### DETAILED DESCRIPTION

Hereinafter, an embodiment of the present technology will be described in detail with reference to the accompanying drawings. It is to be noted that description is made in the following order.

1. Embodiment

2. Modification

3. Example

### 1. Embodiment

### [Configuration]

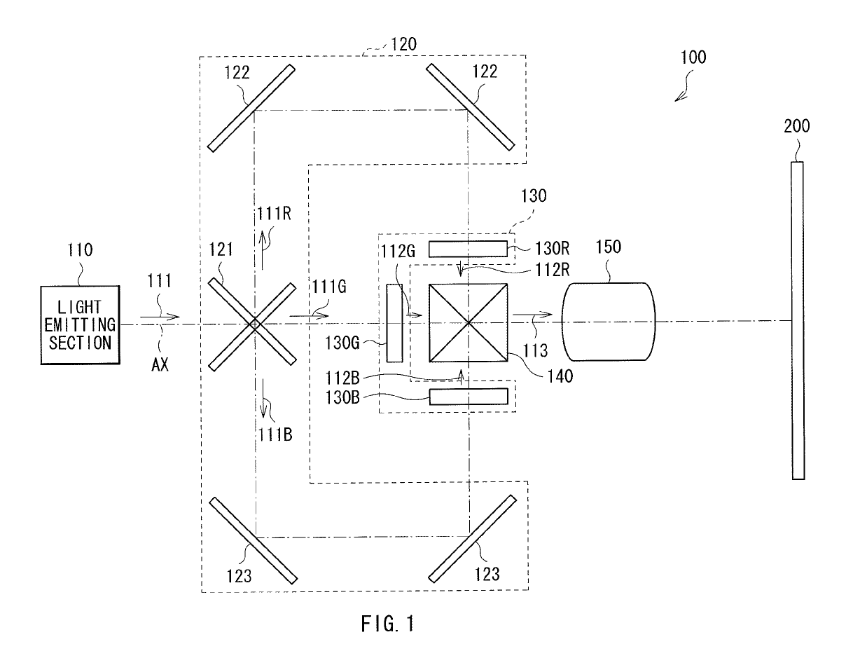

FIG. 1 illustrates an example of an overall configuration of a projector 100 according to an embodiment of the present technology. The projector 100 corresponds to a specific example of “projection display”. For example, the projector 100 projects an image displayed on a screen of an undepicted information processing unit onto a screen 200.

For example, the projector 100 is a three-plate-type transmissive projector, and, for example, includes a light emitting section 110, an optical path splitting section 120, a spatial light modulation section 130, a synthesizing section 140, and a projection section 150.

The light emitting section 110 supplies a luminous flux which is applied to a surface to be irradiated of the spatial light modulation section 130, and, for example, includes a lamp as a white light source, and a reflecting mirror provided at the back of the lamp. The light emitting section 110 may have a certain optical device in a region (on a light axis AX) through which light 111 from the lamp passes, as necessary. For example, a filter that reduces the light 111 from the lamp except for visible light, and an optical integrator that makes distribution of illuminance be uniform on the surface to be irradiated of the spatial light modulation section 130 may be provided in this order from the lamp side on the light axis AX of the lamp.

The beam splitting section 120 splits the light 111 output from the light emitting section 110 into a plurality of color light components having different wavelength bands, and guides each color light component to the surface to be irradiated of the spatial light modulation section 130. For example, as illustrated in FIG. 1, the beam splitting section 120 includes one cross mirror 121, two mirrors 122, and two mirrors 123. The cross mirror 121 splits the light 111 output from the light emitting section 110 into the plurality of color light components having different wavelength bands, and diverges an optical path for each of the color light components. For example, the cross mirror 121 is disposed on the light axis AX, and includes two mirrors different in wavelength selectivity, which are connected to intersect with each other. The mirrors 122 and 123 reflect color light components (red light 111R and blue light 111B in FIG. 1) each having the optical path defined by the cross mirror 121, and are disposed at positions other than those on the light axis AX. The minors 122 are disposed to guide the light component (the red light 111R in FIG. 1) reflected in one of directions intersecting the light axis AX by one minor included in the cross minor 121 to a surface to be irradiated of a spatial light modulation section 130R (described later). The minors 123 are disposed to guide the light component (the blue light 111B in FIG. 1) reflected in the other of the directions intersecting the light axis AX by the other minor included in the cross minor 121 to a surface to be irradiated of a spatial light modulation section 130B (described later). Another light component (green light 111G in FIG. 1) of the light 111 output from the light emitting section 110 is transmitted through the cross minor 121 and passes along the light axis AX, which enters a surface to be irradiated of a spatial light modulation section 130G (described later) disposed on the light axis AX.

The spatial light modulation section 130 modulates each of the color light components in response to an image signal Din received from the undepicted information processing unit, and thus generates modulated light for each of the color light components. For example, the spatial light modulation section 130 includes the spatial light modulation section 130R that modulates the red light 111R, the spatial light modulation section 130G that modulates the green light 111G, and the spatial light modulation section 130B that modulates the blue light 111B.

The spatial light modulation section 130R is disposed in a region opposed to a first surface of the synthesizing section 140. The spatial light modulation section 130R generates red image light 112R through modulating the received red light 111R based on the image signal Din, and outputs the red image light 112R to the first surface of the synthesizing section 140 located at the back of the spatial light modulation section 130R. The spatial light modulation section 130G is disposed in a region opposed to a second surface of the synthesizing section 140. The spatial light modulation section 130G generates green image light 112G through modulating the received green light 111G based on the image signal Din, and outputs the green image light 112G to the second surface of the synthesizing section 140 located at the back of the spatial light modulation section 130G The spatial light modulation section 130B is disposed in a region opposed to a third surface of the synthesizing section 140. The spatial light modulation section 130B generates blue image light 112B through modulating the received blue light 111B based on the image signal Din, and outputs the blue image light 112B to the third surface of the synthesizing section 140 located at the back of the spatial light modulation section 130B.

The synthesizing section 140 generates image light through synthesizing a plurality of pieces of modulated light. The synthesizing section 140, which is disposed, for example, on the light axis AX, is a cross prism including four prisms bonded to one another, for example. For example, each of the bonded surfaces of the prisms has two selective reflection surfaces having different types of wavelength selectivity thereon. The two selective reflection surfaces are each configured of a multilayer interface film, for example. For example, one selective reflection surface reflects the red image light 112R output from the spatial light modulation section 130R in a direction parallel to the light axis AX, and guides the reflected red image light 112R in a direction toward the projection section 150. For example, the other selective reflection surface reflects the blue image light 112B output from the spatial light modulation section 130B in a direction parallel to the light axis AX, and guides the reflected blue image light 112B in a direction toward the projection section 150. The green image light 112G output from the spatial light modulation section 130G is transmitted through the two selective reflection surfaces, and advances toward the projection section 150. Finally, the synthesizing section 140 functions to synthesize the respective colors of image light generated by the spatial light modulation sections 130R, 130G, and 130B to generate image light 113, and output the generated image light 113 to the projection section 150.

The projection section 150 projects the image light 113 output from the synthesizing section 140 on the screen 200 for image display. The projection section 150 is disposed, for example, on the light axis AX, and is configured of, for example, a projection lens.

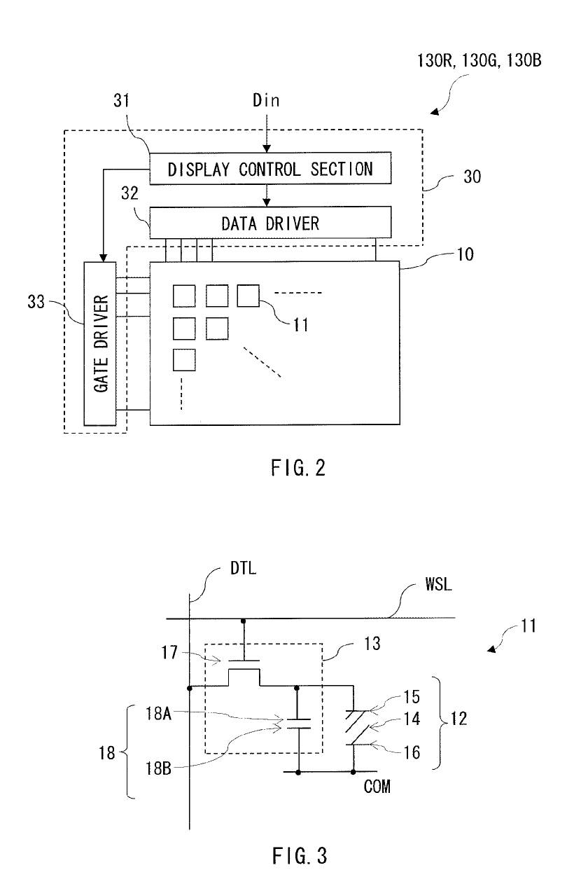

FIG. 2 illustrates an example of an overall configuration of each of the spatial light modulation sections 130R, 130G, and 130B illustrated in FIG. 1. For example, each of the spatial light modulation sections 130R, 130G, and 130B includes a liquid crystal panel 10 and a drive circuit 30 that drives the liquid crystal panel 10. The drive circuit 30 includes a display control section 31, a data driver 32, and a gate driver 33. It is to be noted that the liquid crystal panel 10 corresponds to a specific example of “spatial light modulation device”. In addition, the drive circuit 30 corresponds to a specific example of “drive circuit”.

The liquid crystal panel 10 includes a plurality of pixels 11 provided in a matrix over the entire display region. The liquid crystal panel 10 active-drives the pixels 11 with use of the data driver 32 and the gate driver 33, and thus displays an image based on the externally received, image signal Din.

The liquid crystal panel 10 includes a plurality of scan lines WSL extending in a row direction, a plurality of signal lines DTL extending in a column direction, and a plurality of common connection lines COM extending in the row direction. The pixel 11 is provided in correspondence to an intersection of each signal line DTL and each scan line WSL (FIG. 3). Each signal line DTL is connected to an output end (not illustrated) of the data driver 32. Each scan line WSL is connected to an output end (not illustrated) of the gate driver 33. Each common connection line COM is connected to an output end (not illustrated) of a circuit that outputs a fixed potential, for example.

For example, the display control section 31 stores and holds the supplied image signal Din in a frame memory for every one screen (for every one frame display). In addition, for example, the display control section 31 has a function to control the data driver 32 and the gate driver 33, which drive the liquid crystal panel 10, to operate in conjunction with each other. In detail, for example, the display control section 31 supplies a scan timing control signal to the data driver 32, and supplies an image signal for one horizontal line based on the image signal held in the frame memory and a display-timing control signal to the data driver 32.

For example, the data driver 32 supplies the image signal Din, as a signal voltage, for one horizontal line supplied from the display control section 31 to the pixels 11. In detail, for example, the data driver 32 supplies the signal voltage corresponding to the image signal Din to the pixels 11 defining the horizontal line selected by the gate driver 33 through the signal lines DTL.

For example, the gate driver 33 has a function of selecting a pixel 11 to be driven in response to the scan timing control signal supplied from the display control section 31. In detail, for example, the gate driver 33 applies a selection pulse to a gate (described later) of a transistor 17 of each pixel 11 through the scan line WSL, and thus selects one row of pixels 11 among the pixels 11 provided in a matrix in the display region. The selected pixels 11 perform image display for one horizontal line in response to the signal voltage supplied from the data driver 32. In this way, for example, the gate driver 33 time-divisionally performs sequential scan by one horizontal line basis for image display over the entire display region.

A circuit configuration of the pixel 11 is now described. FIG. 3 illustrates an exemplary circuit configuration of the pixel 11. The pixel 11 includes a liquid crystal device 12, and a pixel circuit 13 that drives the liquid crystal device 12. The liquid crystal device 12 and the pixel circuit 13 are provided in correspondence to an intersection of each scan line WSL and each signal line DTL. The liquid crystal device 12 is configured of a liquid crystal cell 14, a pixel electrode 15, and a common electrode 16, the pixel electrode 15 and the common electrode 16 sandwiching the liquid crystal cell 14. The pixel circuit 13 is configured of the transistor 17 that writes the signal voltage to the liquid crystal device 12, and a storage capacitor 18 that holds the voltage written to the liquid crystal device 12.

The liquid crystal cell 14 allows gray-scale display through light modulation due to a variation in alignment of liquid crystal molecules depending on a level of an applied voltage. For example, the liquid crystal cell 14 includes nematic liquid crystal. The pixel electrode 15 functions as an electrode for each pixel 11, and, for example, is formed of a transparent conductive material such as indium tin oxide (ITO). The pixel electrode 15 is connected to a drain of the transistor 17. The common electrode 16 is provided over the entire region opposed to all the pixel electrodes 15, and functions as a common electrode for the pixels 11. The common electrode 16 is connected to the common connection lines COM.

The transistor 17 is a field-effect thin film transistor (TFT) device. It is to be noted that the internal configuration of the transistor 17 is described in detail later. The storage capacitor 18 is for preventing leakage of the signal voltage held between the pixel electrode 15 and the common electrode 16, and is configured of a pair of capacitor electrodes 18A and 18B opposed to each other with a predetermined gap therebetween. The capacitor electrode 18A is connected to the drain of the transistor 17, and the capacitor electrode 18B is connected to the common connection line COM.

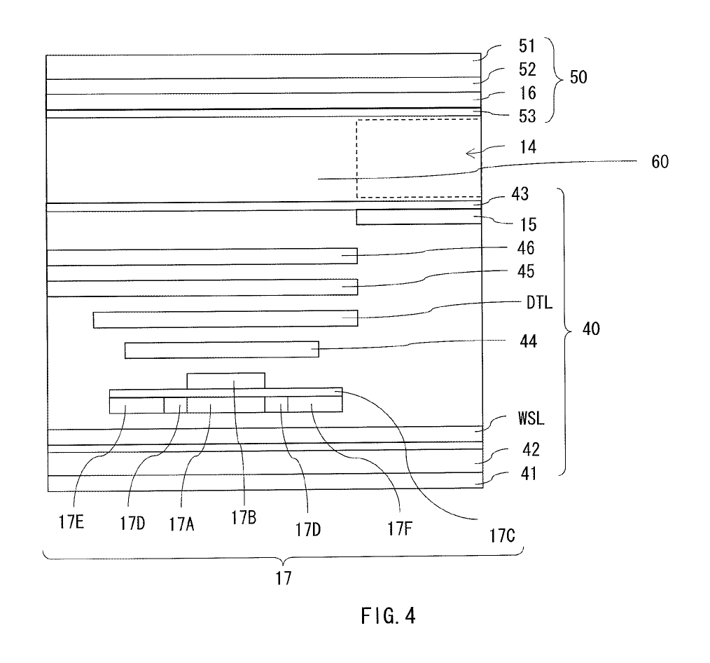

A sectional configuration of a portion including the pixel 11 and its periphery of the liquid crystal panel 10 is now described. FIG. 4 illustrates an exemplary sectional configuration of the pixel 11 and its vicinity of the liquid crystal panel 10. The liquid crystal panel 10 includes a TFT substrate 40, a counter substrate 50, and a liquid crystal layer 60 sandwiched between the substrates. The liquid crystal layer 60 includes, for example, nematic liquid crystal, and has a region, which is opposed to the pixel electrodes 15, corresponding to the above-described liquid crystal cell 14.

For example, the TFT substrate 40 includes a polarizing plate 41, a support substrate 42, the transistors 17, the pixel electrodes 15, and an alignment film 43 in order from a side opposite to a side closer to the counter substrate 50. Furthermore, the TFT substrate 40 includes the scan lines WSL, the signal lines DTL, the common connection lines COM (not illustrated), and light blocking layers 44, 45, and 46. For example, the counter substrate 50 includes a polarizing plate 51, a support substrate 52, the common electrode 16, and an alignment film 53 in order from a side closer to an emission surface of image light.

For example, the polarizing plates 41 and 51 are in crossed Nichol arrangement so as to exclusively transmit light (polarized light) in a certain oscillation direction. The alignment films 43 and 53 each align the liquid crystal molecules contained in the liquid crystal layer 60. The light blocking layer 45 is a layer having the same potential as that of the capacitor electrode 18B. The light blocking layer 46 is a layer having the same potential as that of the capacitor electrode 18A. It is to be noted that the light blocking layer 44 is described in detail later.

The transistor 17 is a TFT device, and has a lightly doped drain (LDD) structure. The transistor 17 includes a channel region 17A, a gate 17B that applies an electric field to the channel region 17A, and a gate insulating film 17C that isolates the channel region 17A from the gate 17B. The transistor 17 further includes LDD regions 17D provided on both sides of the channel region 17A, and a source region 17E and a drain region 17F provided on respective outer sides of the LDD regions 17D. In the transistor 17, the source region 17E is connected to the signal line DTL, the gate 17B is connected to the scan line WSL, and the drain region 17F is connected to the pixel electrode 15.

The channel region 17A, the LDD regions 17D, the source region 17E, and the drain region 17F are, for example, provided in the same layer, and, for example, are formed of amorphous silicon, polycrystalline silicon, single-crystalline silicon, and/or the like. The source region 17E and the drain region 17F are each doped with an impurity, for example, an n-type impurity. The LDD regions 17D are doped with an impurity such that impurity concentration thereof is lower than that of the source region 17E and of the drain region 17F.

The signal line DTL is disposed between a layer including the transistor 17 and a layer including the pixel electrode 15. The signal line DTL is disposed directly above (in a region opposed to) at least the LDD regions 17D, and is specifically disposed directly above (in a region opposed to) the LDD regions 17D and the channel region 17A. For example, the signal line DTL is provided extending across the region opposed to the LDD regions 17D. For example, the scan line WSL is disposed between the support substrate 42 and the layer including the transistor 17. The scan line WSL is disposed, for example, directly below (in a region opposed to) at least the LDD regions 17D, and is specifically disposed, for example, directly below (in a region opposed to) the LDD regions 17D and the channel region 17A. For example, the scan line WSL is provided extending across the region opposed to the LDD regions 17D. The light blocking layers 45 and 46 are disposed, for example, between the layer including the transistor 17 and a layer including the alignment film 43. The light blocking layers 45 and 46 are disposed, for example, directly above (in a region opposed to) at least the LDD regions 17D, and is specifically disposed, for example, directly above (in a region opposed to) the LDD regions 17D and the channel region 17A.

The signal line DTL and the light blocking layers 45 and 46 are each preferably disposed directly above (in the region opposed to) at least the LDD regions 17D, and more preferably disposed directly above (in the region opposed to) the LDD regions 17D and the channel region 17A.

The light blocking layer 44 is now described. The light blocking layer 44 is configured of a light blocking material, and is electrically floating. The light blocking layer 44 corresponds to a specific example of “floating light-blocking layer”. For example, the light blocking layer 44 is provided by one for each pixel circuit 13. It is to be noted that the light blocking layer may be provided by one for a plurality of pixel circuits 13, for example, by one for each pixel row.

The light blocking layer 44 blocks light incident from a side closer to the counter substrate 50 from entering at least the LDD regions 17D, and preferably, blocks light incident from the side closer to the counter substrate 50 from entering the LDD regions 17D and the channel region 17A. The light blocking layer 44 is disposed between the layer including the LDD regions 17D and the layer including the signal line DTL. The light blocking layer 44 is disposed directly above at least the LDD regions 17D, and is preferably disposed directly above the LDD regions 17D and the channel region 17A.

### [Operation]

An exemplary operation of the projector 100 is now described. In the projector 100, based on the image signal Din supplied from the outside, the image signal Din for one horizontal line is supplied to the data driver 32, and the timing control signal is supplied to the data driver 32 and the gate driver 33. Then, the signal voltage corresponding to the image signal Din is applied to the signal line DTL, and frame inversion drive is performed. In addition, a selection pulse is applied to the gate of the transistor 17 of the pixel 11 through the scan line WSL. As a result, each selected pixel 11 emits light having luminance corresponding to the signal voltage, leading to image display for one horizontal line, and in turn, leading to image display over the entire display region through sequential scan by the gate driver 33.

### [Effect]

Next, description is made on the effect of the light blocking layer 44 in each of the spatial light modulation sections 130R, 130G, and 130B. In each of the spatial light modulation sections 130R, 130G, and 130B, the light blocking layer 44 is disposed in the region opposed to at least the LDD regions 17D, and is disposed closer to the LDD regions 17D than the signal line DTL. This allows the light blocking layer 44 to block not only a straight component of light but also an oblique component thereof from entering the LDD regions 17D. Furthermore, the light blocking layer 44 is electrically floating. This eliminates occurrence of troubles such as degradation in image quality due to an increase in parasitic capacitance, and an increase in inverse current in the transistor 17 unlike in the case where the signal line DTL is disposed close to the LDD regions 17D. In addition, in the case where the light blocking layer 44 is disposed between the LDD regions 17D and the signal line DTL, the light blocking layer 44 prevents an electric field generated by the signal voltage from reaching the LDD regions 17D. Consequently, the light blocking layer 44 improves light blocking performance of each of the spatial light modulation sections 130R, 130G, and 130B while suppressing occurrence of the above-described troubles.

### 2. Modification

In the embodiment, the light blocking layer 44 may be connected to a wiring having high resistance. In such a case, the light blocking layer 44 is also considered to be virtually floating.

### 3. Example

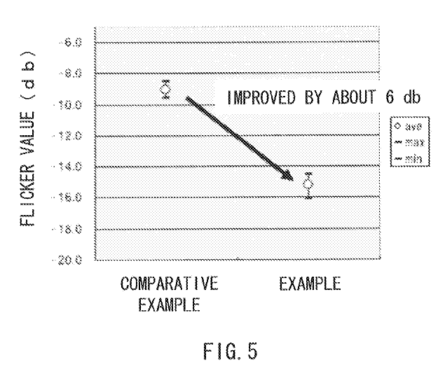

FIG. 5 illustrates a measured result of flicker in the case where liquid crystal panels according to Example and a comparative example are irradiated with light. A smaller flicker value indicates higher light resistance. In the liquid crystal panel according to the Example, the light blocking layers 44, 45, and 46 and the signal line DTL are disposed directly above the LDD regions 17D and the channel region 17A as illustrated in FIG. 4. On the other hand, in the liquid crystal panel according to the comparative example, although the light blocking layers 45 and 46 and the signal line DTL are disposed directly above the LDD regions 17D and the channel region 17A, the light blocking layer 44 is not disposed. FIG. 5 reveals that flicker is reduced as much as about 6 dB by providing the light blocking layer 44 directly above the LDD regions 17D and the channel region 17A.

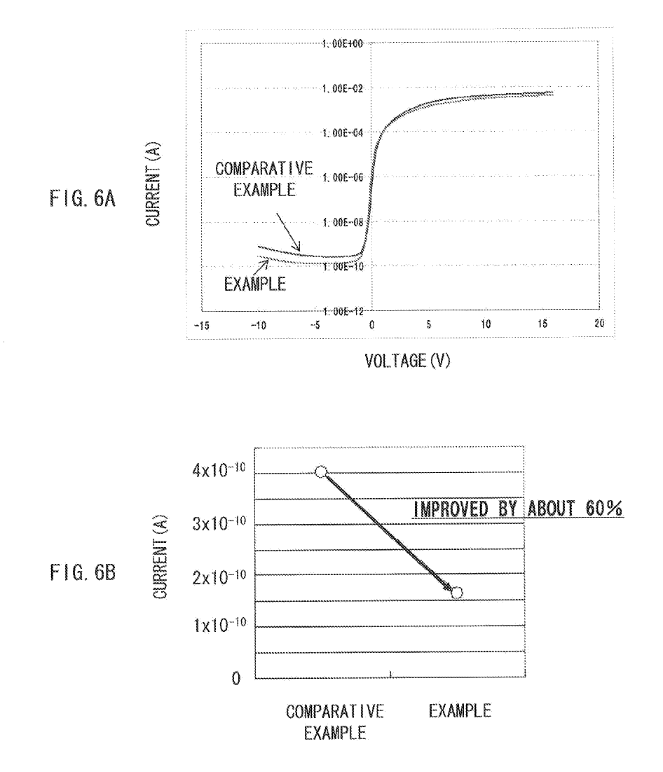

FIG. 6A illustrates a measured result of I-V characteristics in the case where liquid crystal panels according to Example and a comparative example are irradiated with light. FIG. 6B illustrates current values at a voltage of −7.5 V extracted from FIG. 6A. The Example and the comparative example illustrated in FIGS. 6A and 6B have configurations similar to those described above. FIGS. 6A and 6B reveal that an inverse current is reduced as much as about 60% by providing the light blocking layer 44 directly above the LDD regions 17D and the channel region 17A.

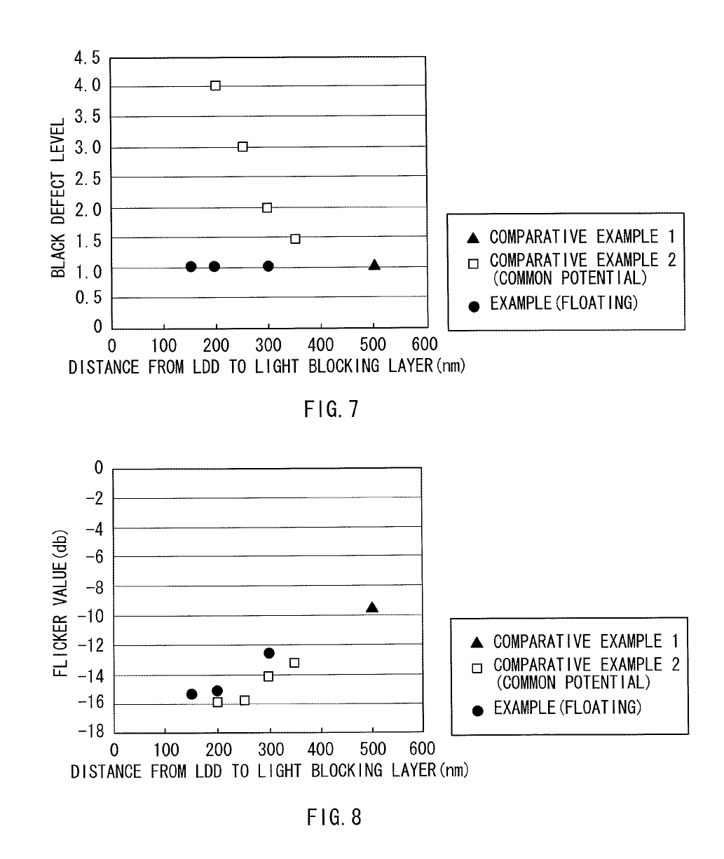

FIG. 7 illustrates a measured result of a black defect level in the case where the liquid crystal panels according to Example and comparative examples are irradiated with light. The black defect level indicates a level of insufficient white gray-scale due to insufficient charge of a pixel when the pixel receives a signal voltage corresponding to white gray-scale. A higher black defect level indicates more insufficient charge of a pixel. There were prepared a liquid crystal panel having no light blocking layer 44 (comparative example 1); a liquid crystal panel having a light blocking layer provided at the same position as that of the light blocking layer 44, to which the same potential (common potential) as that of the common connection line COM is applied (comparative example 2); and a liquid crystal panel having the floating light-blocking layer 44 (Example). FIG. 7 reveals that even if the light blocking layer is disposed close to the LDD regions 17D, the black defect level is controlled to be low by setting the light-blocking layer to be floating.

FIG. 8 illustrates a measured result of flicker values in the case where liquid crystal panels according to Example and the comparative examples are irradiated with light. There were prepared liquid crystal panels according to the comparative example 1, the comparative example 2, and Example, as in FIG. 7. FIG. 8 reveals that a flicker value is controlled to be low regardless of an electric potential of the light blocking layer by disposing the light blocking layer close to the LDD regions 17D.

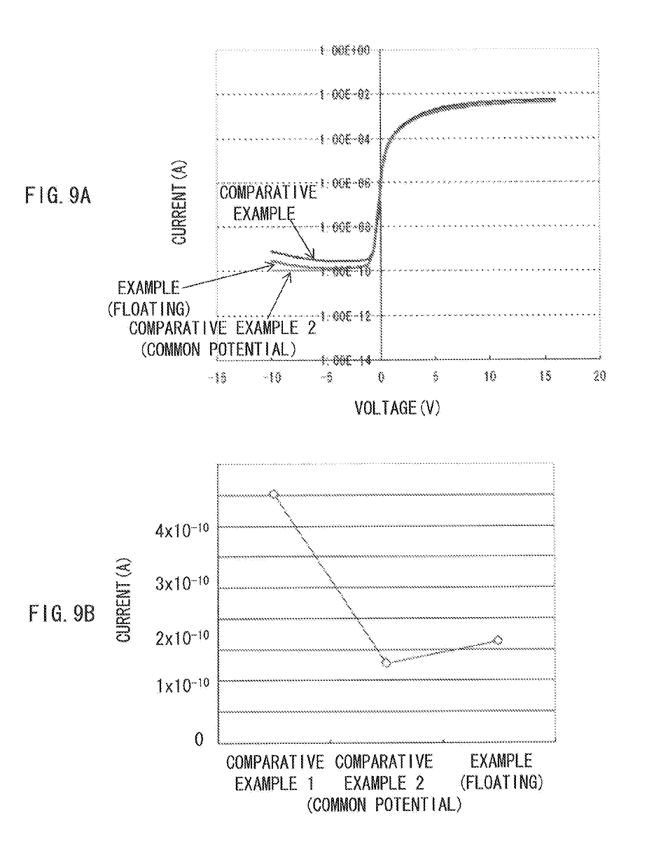

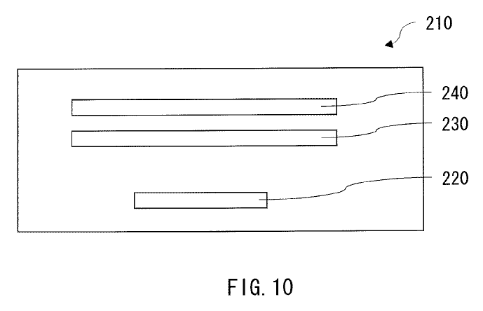

FIG. 9A illustrates a measured result of I-V characteristics in the case where liquid crystal panels according to Example and comparative examples are irradiated with light. FIG. 9B illustrates current values at a voltage of −7.5 V in FIG. 9A. There were prepared liquid crystal panels according to the comparative example 1, the comparative example 2, and Example, as in FIG. 7. FIGS. 9A and 9B reveal that although the light blocking layer having a common potential is most effective to reduce the inverse current, the floating light-blocking layer may also reduce the inverse current as much as about 60% compared with a case of no light blocking layer.

As described above, the floating light-blocking layer may reduce any of the flicker value, the inverse current value, and the black defect level.

Moreover, for example, the present technology may be configured as follows.

(1) A spatial light modulation device, including:

a plurality of pixel circuits provided in correspondence to intersections of scan lines and signal lines; and

floating light-blocking layers provided in correspondence to the pixel circuits,

wherein each of the pixel circuits includes a thin film transistor (TFT) device including a lightly doped drain (LDD) region, and

each of the floating light-blocking layers is disposed in a region opposed to at least the LDD region, and is disposed closer to the LDD region than the signal line.

(2) The spatial light modulation device according to (1),

wherein the TFT device includes a channel region, and

the floating light-blocking layer is disposed also in a region opposed to the channel region.

(3) The spatial light modulation device according to (1) or (2), wherein the signal line is provided extending across the region opposed to the LDD region.

(4) The spatial light modulation device according to any one of (1) to (3), wherein the scan line is provided extending across the region opposed to the LDD region.

(5) A projection display including a spatial light modulation device, and a drive circuit driving the spatial light modulation device, the spatial light modulation device including:

a plurality of pixel circuits provided in correspondence to intersections of scan lines and signal lines; and

floating light-blocking layers provided in correspondence to the pixel circuits,

wherein each of the pixel circuits includes a thin film transistor (TFT) device including a lightly doped drain (LDD) region, and

each of the floating light-blocking layers is disposed in a region opposed to at least the LDD region, and is disposed closer to the LDD region than the signal line.

The present disclosure contains subject matter related to that disclosed in Japanese Priority Patent Application JP 2011-196398 filed in the Japan Patent Office on Sep. 8, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A spatial light modulation device comprising:
a plurality of pixel circuits provided in correspondence to intersections of scan lines and signal lines; and
floating light-blocking layers provided in correspondence to the pixel circuits,
wherein each of the pixel circuits includes a thin film transistor (TFT) device including a lightly doped drain (LDD) region, and
each of the floating light-blocking layers is disposed in a region opposed to at least the LDD region, and is disposed closer to the LDD region than the signal line.

2. The spatial light modulation device according to claim 1,
wherein the TFT device includes a channel region, and
the floating light-blocking layer is disposed also in a region opposed to the channel region.

3. The spatial light modulation device according to claim 1, wherein the signal line is provided extending across the region opposed to the LDD region.

4. The spatial light modulation device according to claim 3, wherein the scan line is provided extending across the region opposed to the LDD region.

5. A projection display including a spatial light modulation device, and a drive circuit driving the spatial light modulation device, the spatial light modulation device comprising:
a plurality of pixel circuits provided in correspondence to intersections of scan lines and signal lines; and
floating light-blocking layers provided in correspondence to the pixel circuits,
wherein each of the pixel circuits includes a thin film transistor (TFT) device including a lightly doped drain (LDD) region, and
each of the floating light-blocking layers is disposed in a region opposed to at least the LDD region, and is disposed closer to the LDD region than the signal line.
